(19) United States
(12) Patent Application Publication
(10) Pub. No.: US 2013/0309511 A1
(43) Pub. Date: Nov. 21, 2013

(54) METHODS FOR MANUFACTURING GLASS FIBER REINFORCED CONCRETE

(71) Applicant: RSI HOME PRODUCTS MANAGEMENT, INC., Anaheim, CA (US)

(72) Inventor: Damian J. Le Duff, Chula Vista, CA (US)

(73) Assignee: RSI HOME PRODUCTS MANAGEMENT, INC, Anaheim, CA (US)

(21) Appl. No.: 13/893,112

(22) Filed: May 13, 2013

Related U.S. Application Data
(60) Provisional application No. 61/648,026, filed on May 16, 2012.

(51) Int. Cl. B29C 39/00; B32B 13/04; B32B 13/02

(52) U.S. Cl. CPC B29C 39/003; B32B 13/02; B32B 13/04
USPC 428/454; 264/255

(57) ABSTRACT

Embodiments of the present disclosure are directed to a method for manufacturing glass fiber reinforced concrete. The method can comprise selecting a mold, inserting the mold into a carrier, mixing and applying a face mix, installing an insert to create a process tool. The mold may then be filled with a back mix, and the process tool may then be placed in an oven at a target temperature for a target time to achieve a pre-cure. The work piece may then be removed from the process tool and may then be placed in an oven at a temperature for a time to achieve a full cure of the work piece.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

1. Field

The present disclosure is generally related to a method for manufacturing glass fiber reinforced concrete.

2. Description of the Related Art

Glass Fiber Reinforced Concrete (GFRC) has been used in the architectural and construction industries for some time to reduce weight while maintaining many of the benefits of standard concrete.

GFRC is a form of concrete that uses sand, cement, polymer, water, and glass fibers. This mix will often also include pozzolan or flat ash. Traditionally, GFRC was cured at high humidity for 7 days; however, the addition of an acrylic polymer reduces the need for a high humidity cure. The glass fiber will typically be alkali-resistant fiber (AR fiber). AR fibers are added because glass frequently breaks down in an alkaline environment, and concrete is alkaline. AR fibers achieved higher functionality in the 1970's, and have been used in GFRC since.

GFRC products are cured for several days, typically from about 2 to 7 days, a significant amount of time. It is generally believed that the longer the product is allowed to cure the stronger the final product will be. After the product is cured, the product can be sealed and stained to create the desired appearance.

### SUMMARY

Embodiments of the present disclosure are directed to a method for manufacturing a glass fiber reinforced concrete.

In some embodiments, a method for manufacturing a glass fiber reinforced concrete can comprise mixing a face mix comprising fast cement, sand, a polymer, and water, where the water is maintained within a temperature range of about 40° and about 100°, applying the face mix to a mold and stiffening the face mix for about 0 to about 10 minutes, mixing a back mix comprising fast cement, sand, a polymer, water, and glass fibers, where the water is maintained within a temperature range of about 40° to about 100°, applying the back mix to the mold to form a work piece, and curing the work piece at a temperature of about 80° to 150° for less than about 3 hours to form a cured work piece.

In some embodiments, the method can further comprise pre-curing the mold at a temperature of about 80° to about 150° for less than about 3 hours. In some embodiments, the pre-curing the mold can be at about 100° for about 55 minutes. In some embodiments, the water can be maintained within a temperature range of about 63° to about 67°. In some embodiments, the face mix can be stiffened for about 3 to 5 minutes.

In some embodiments, the face mix can be applied to the mold through spraying or vibration premixing. In some embodiments, the method can further comprise applying a concrete release agent to the mold before applying the face mix.

In some embodiments, the face mix can comprise, in weight %, about 35% to about 43% cement, about 35% to about 45% sand, about 1% to about 7% polymer, and about 7% to about 17% water. In some embodiments, the back mix can comprise, in weight %, about 40% to about 50% cement, about 23% to about 33% sand, about 1% to about 7% polymer, about 7% to about 17% water, about 1% to about 10% glass beads, and about 0.5% to about 3% fibers.

In some embodiments, the face mix can be applied to the mold at a thickness of about 0.05 to about 0.5 inches. In some embodiments, the back mix can be applied to the mold at a thickness of about 0.25 to about 2.0 inches. In some embodiments, a work piece can be manufactured from the method described above.

In some embodiments, a method for manufacturing a glass fiber reinforced concrete can comprise applying at least one layer of a face mix and a back mix to a mold, wherein the face mix and the back mix comprise a combination of cement, sand, polymer, fibers, and water, performing a first heat treatment on the mold containing the face mix and the back mix at a temperature of about 80° to about 150° for less than about 3 hours to form a work piece, and performing a second heat treatment on the work piece at a temperature of about 80° to 150° for less than about 3 hours.

In some embodiments, the first and second heat treatment can be performed for about 55 minutes or less. In some embodiments, the face mix can be allowed to stiffen before applying the back mix. In some embodiments, a work piece can be manufactured from the method described above.

In some embodiments, a method for manufacturing a glass fiber reinforced concrete can comprise applying a face mix comprising fast cement, sand, a polymer, and water, where the water is maintained within a first water temperature range, to a mold and stiffening the face mix for a stiffening time, applying a back mix comprising fast cement, sand, a polymer, water, and glass fibers, where the water is maintained within a second water temperature range, to the mold, pre-curing the mold at a pre-cure temperature for a pre-cure time to form a work piece, and curing the work piece at a cure temperature and a cure time to form a cured work piece, wherein the total pre-cure and cure time is less than about 110 minutes.

### BRIEF DESCRIPTION OF THE DRAWINGS

FIG. 1A shows flowchart describing an embodiment of a method of pre-curing glass fiber reinforced concrete.

FIG. 1B shows a flowchart describing an embodiment of a method of curing glass fiber reinforced concrete.

FIG. 1C shows a flowchart describing an embodiment of a method of sealing and staining glass fiber reinforced concrete.

FIG. 2 shows a cross-section view of an embodiment of an assembled process tool.

FIG. 3 shows an exterior view of an embodiment of an assembled process tool.

FIG. 4 shows an embodiment of a carrier which can be used for transportation during manufacturing.

FIG. 5 shows an embodiment of a soft mold shaped for manufacturing of a work piece.

FIG. 6 shows an embodiment of an insert that can be used with conjunction with the mold and carrier to create empty spaced in a work piece.

FIG. 7 shows an embodiment of a finished work piece that can be created from glass reinforced concrete.

### DETAILED DESCRIPTION OF THE PREFERRED EMBODIMENT

Various embodiments of the present disclosure relate to new methods for manufacturing concrete, in particular glass fiber reinforced concrete (GFRC). As described in greater detail below, the methods may involve selecting a mold, mixing a face mix, applying the face mix to the mold, mixing a back mix, inserting the back mix into the mold, pre-curing the work piece in an oven, removing the work piece from the mold, further curing the work piece in an oven, and optionally staining and sealing the work piece. In some embodiments, only one mix can be used throughout the process. However, these steps are not limiting and other steps may be used. In some embodiments, the GFRC can be manufactured in a significantly faster time, that is, hours instead of days. This can be achieved through, for example, temperature or chemical control, or a combination of the two. In some embodiments, the GFRC manufactured from the below description can have reduced weight with all of the standard GFRC strength characteristics.

The terms “approximately”, “about”, and “substantially” as used herein represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

In general, embodiments of the present disclosure comprise GFRC and methods of manufacturing the same. As discussed in greater detail below, through a combination of composition and manufacturing steps, a GFRC can be manufactured with low weight while continuing to have adequate strength requirements. Additionally, the GFRC can be manufactured within hours, a significantly faster cycle rate than standard GFRC processing. The composition of the GFRC layers, as well as the temperatures used during the manufacturing process, can improve manufacturing speeds of the GFRC.

GFRC can be manufactured using either a spray process or a premix vibration casting process. GFRC can be mixed and then applied to a mold, either by spraying or pouring into a mold and then vibrating. In some embodiments, a two-step process can be used involving a premix (or face mix) and a backer mix (or back mix). These two mixes can have approximately equivalent ratios of wet cement and polymer to prevent curling and allow proper bonding. It is also possible to use thinner layers than were possible with Portland Cement because GFRC has high strength characteristics. This further reduces the necessary materials. In some embodiments, only one mix can be used when manufacturing the GFRC, thereby reducing the number of steps.

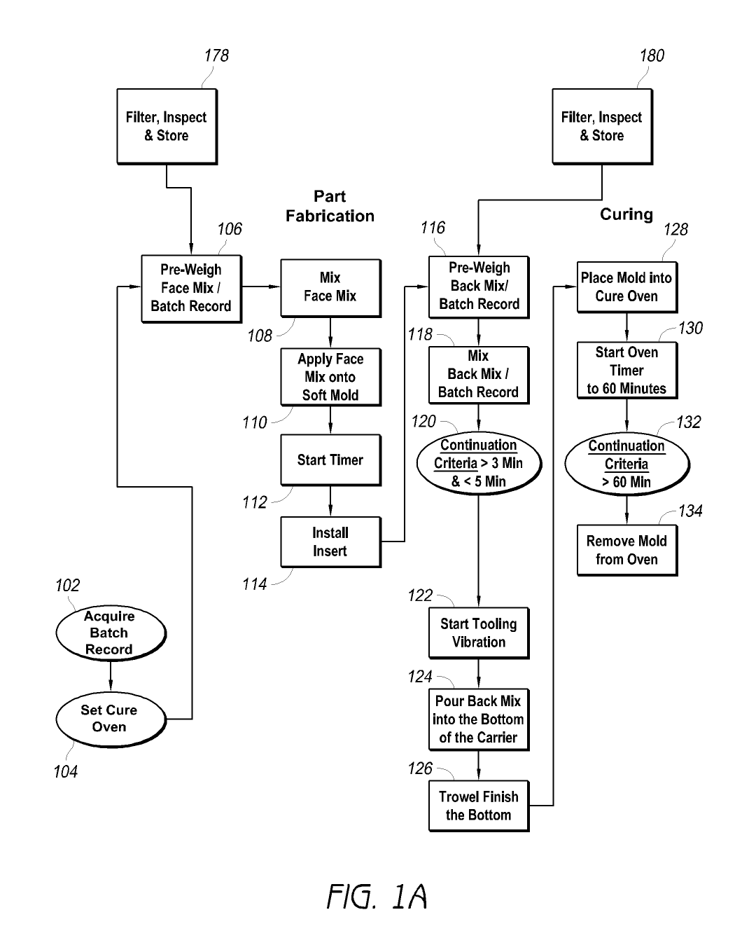

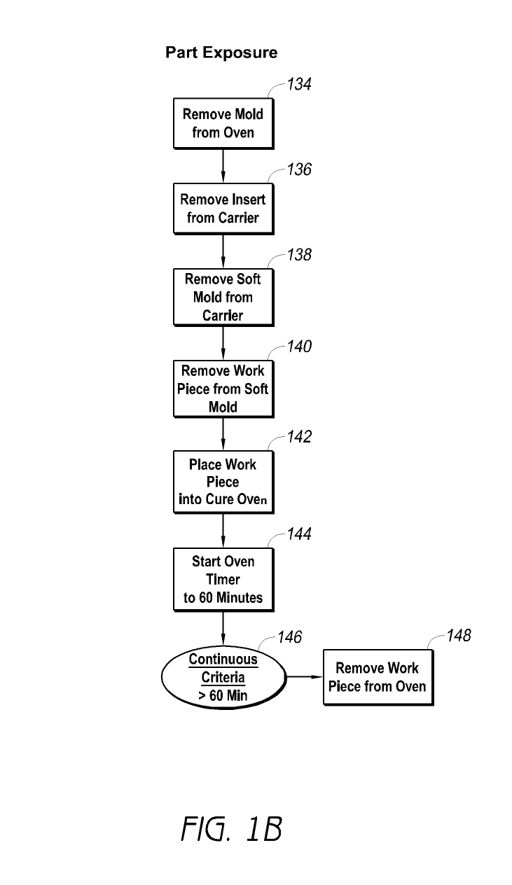

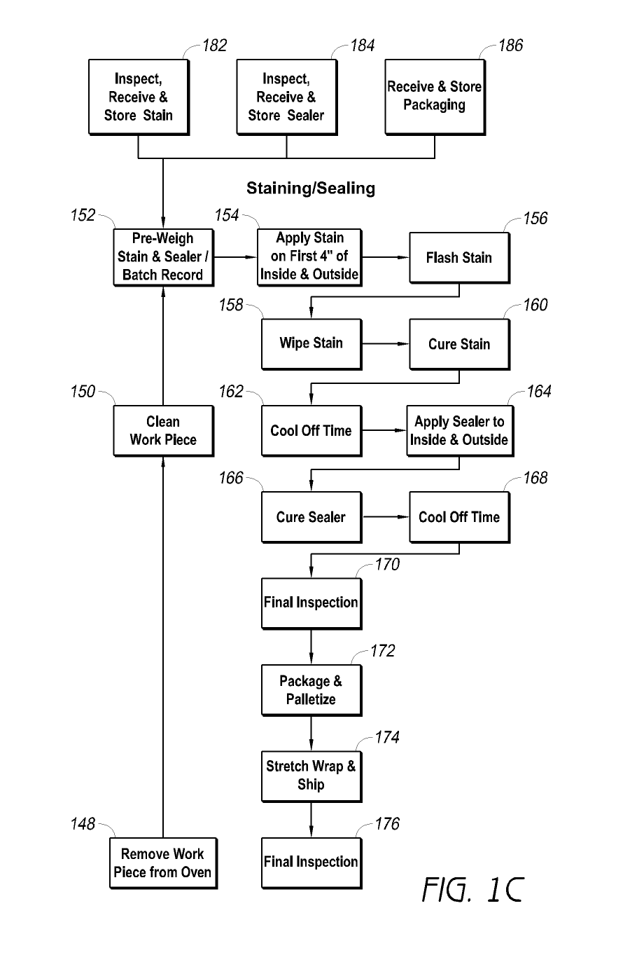

FIGS. 1A-C illustrate flowcharts for an embodiment of a method of manufacturing GFRC. FIG. 1A shows an embodiment of a method for pre-curing glass fiber reinforced concrete. As illustrated, in some embodiments, a batch record is acquired 102. The batch record can contain the information or recipe for manufacturing a work piece. The batch record can include information regarding the appropriate soft mold, carrier and insert.

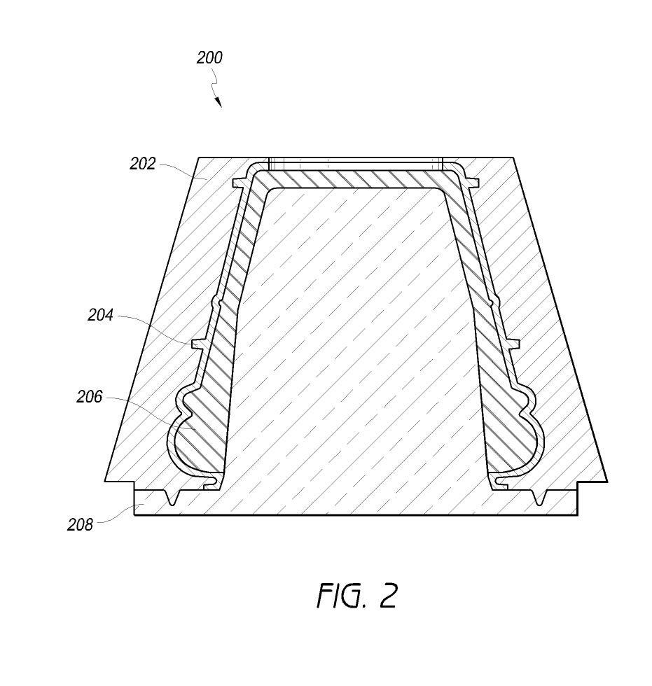

FIG. 2 shows a cross-sectional view of an embodiment of an assembled process tool 200, which can comprise the carrier 202, the soft mold 204, the work piece 206, and the insert 208. The process tool 200 can travel on a conveyor belt through the pre-curing process; however other methods of transportation can be used.

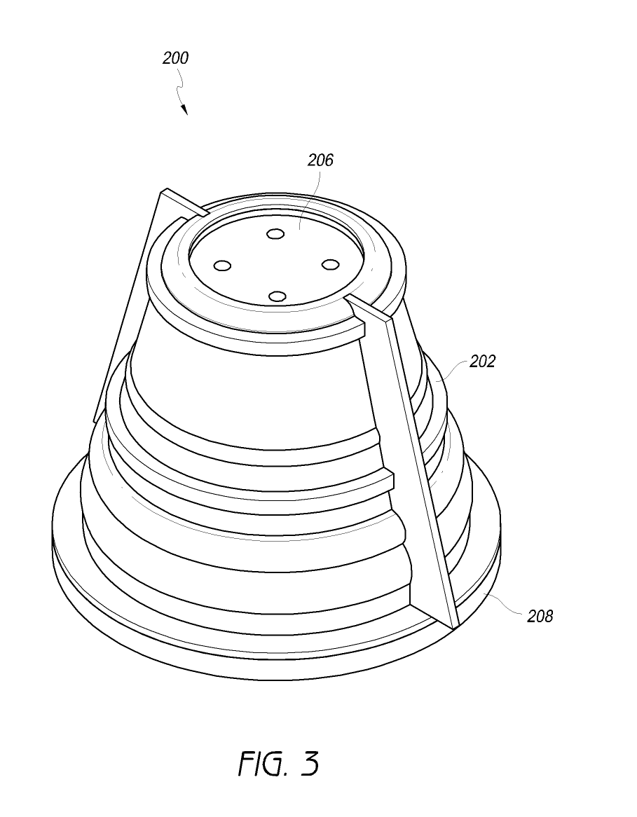

FIG. 3 shows an exterior view of an embodiment of an assembled process tool 200, which can comprise the carrier 202, the soft mold 204 (not shown), the work piece 206, and the insert 208.

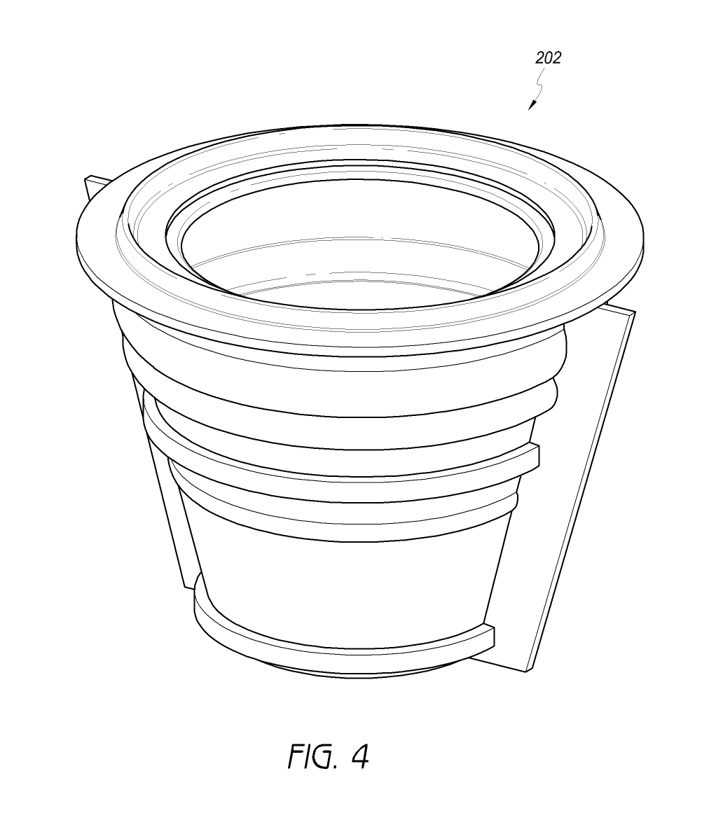

FIG. 4 shows an embodiment of a carrier 202 with the reverse perspective. The carrier can fit on the outside of the soft mold 204 and can allow the mold 204 to be transported throughout the manufacturing process.

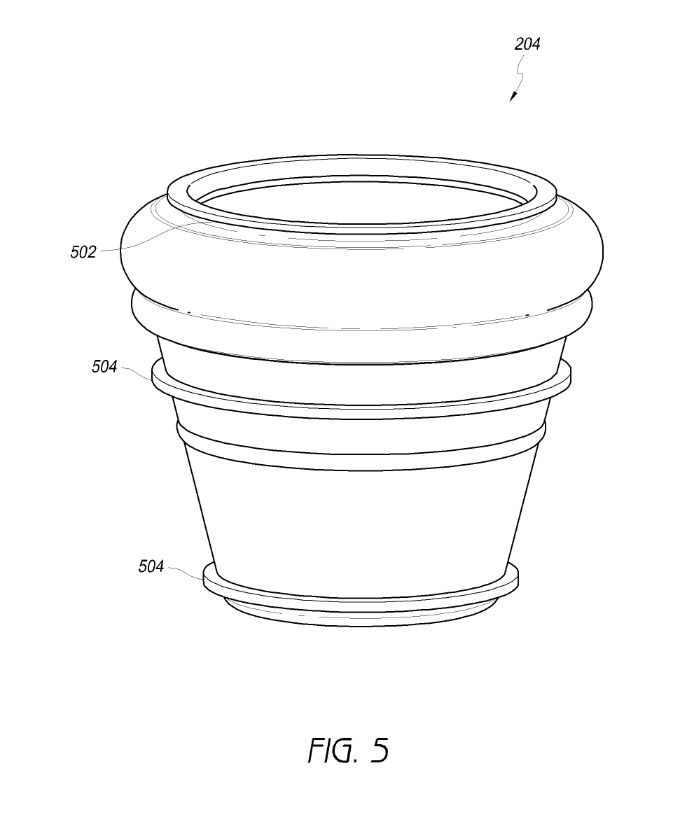

FIG. 5 shows an embodiment of the soft mold 204. The soft mold 204 can be a silicone mold, or some other flexible mold, and the material of the mold is not limiting. The mold 204 can have a channel 502 where the carrier 202 can hold the soft mold 204. The soft mold 204 also can have interlocks 504 to secure the soft mold 204 to the carrier tool 202. In some embodiments, flashing can be avoided.

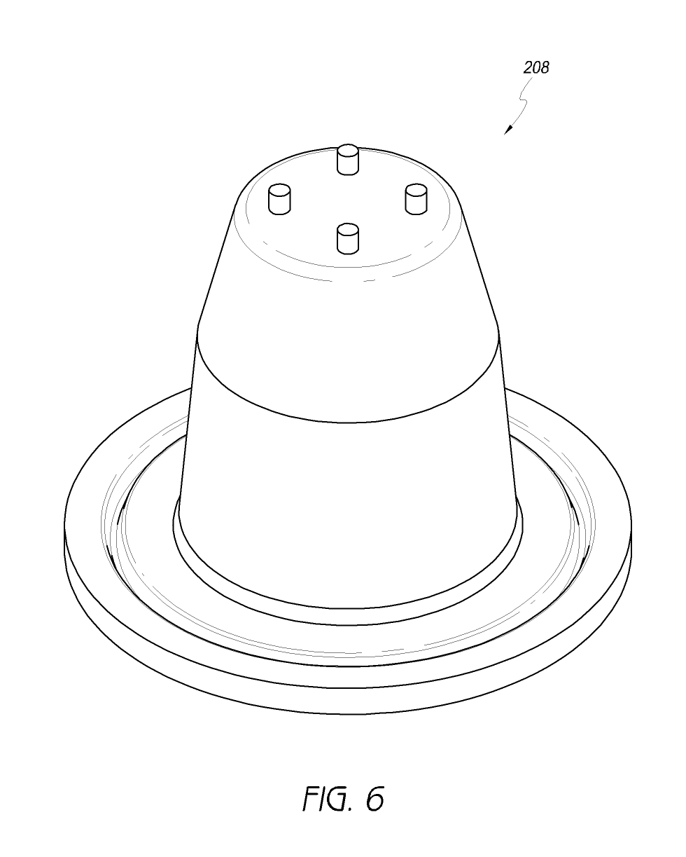

FIG. 6 shows an embodiment of the insert 208. The insert 208 can be a piece that can be used to create a hole or space within the work piece, such as the inside of a vase or pot. The insert 208 can be used to create any number of inner spaces in a work piece, and the dimensions and configurations of the insert 208 is not limiting.

FIGS. 2-6 illustrate embodiments of a process tool 200 using a carrier 202, a soft mold 204 and an insert 208. In some embodiments, a two piece manufacturing process can be used, where the soft mold 204 may not be used to manufacture the work piece 206. In some embodiments, a single piece tool, such as the carrier 202 alone or the soft mold 204 alone can be used to manufacture the work piece 206. The number and configuration of tool pieces used to manufacture the work piece 206 is not limiting, and different numbers and configurations can be used, such as a one-piece or two-piece process tool.

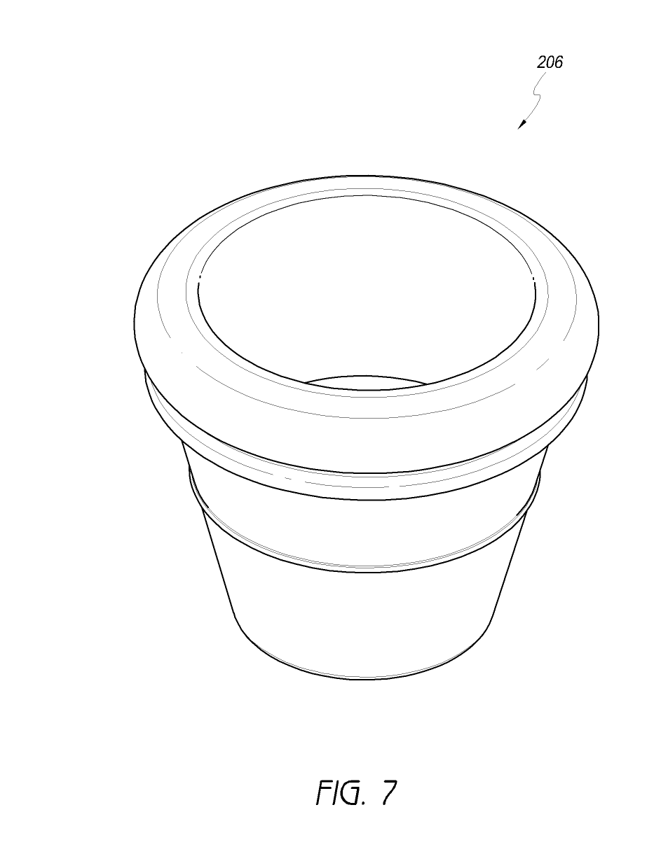

FIG. 7 shows an embodiment of a sample work piece 206. The work piece 206 can comprise glass reinforced concrete. While the sample work piece 206 is shaped generally like a vase or pot, other work pieces can also be manufactured, such as, for example, cones, pillars, or more intricate designs.

Referring back to FIG. 1A, the batch record may contain information regarding the appropriate oven temperature and oven retention time. The oven may be set 104 so that the oven will reach the target temperature by the time the work piece enters the oven. In some embodiments, the temperature of the oven can be greater than about 80° F., greater than about 90° F. or preferably greater than about 100° F. The temperature of the oven may be less than about 150° F., less than about 140° F., less than about 130° F., or preferably less than about 120° F. In other embodiments, the oven temperature can be between about 60° F. to about 140° F., between about 90° F. and 110° F., more preferably between about 95° F. and 105° F. However, if the temperature is raised too high, this can cause changes in the color of the work piece. For example, oven temperatures greater than 200° F. can result in color changes in the work piece, which may not be preferable. However, in some embodiments, high temperatures could be used to acquire the color changes.

The face mix is a mixture that can be applied directly to the mold. In some embodiments, the face mix comprises cement, sand, polymer and water. These components may be filtered, inspected, and stored 178 before pre-weighing the components. These components may be pre-weighed before mixing 106. In other embodiments, the face mix can comprise white or gray fast cement, sand, an acrylic modified polymer, and water. In some embodiments, the cement is present in the face mixture at about 10% to about 70% by weight, about 35% to about 45% by weight, about 39% to about 43% by weight, or about 41% by weight. In some embodiments, the sand is present in the face mix at about 10% to about 70% by weight, about 35% to about 45% by weight, about 39% to about 43% by weight, or about 41% by weight. In some embodiments the polymer is present in the mix at about 0.05% to about 30% by weight, about 1% to about 7% by weight, about 2% to about 6%, or about 4% by weight. In some embodiments, the water is present in the face mix at about 1% to about 42% by weight, about 7% to about 17% by weight, about 10% to about 15% by weight, or about 12.5% by weight. In some embodiments, pigments or other materials are added to create a target aesthetic or textured finish. In addition, other components can be added to change specific properties, such as strength or durability, in the face mix.

In some embodiments, the temperature of the water can be precisely controlled during the mixing of the face mix. In some embodiments, the temperature of the water is greater than about 40° F., greater than about 50° F., or greater than about 60° F. In some embodiments, the temperature of the water is less than about 100° F., less than about 90° F., less than about 80° F. or less than about 70° F. In other embodiments, the temperature of the water is controlled to between about 35° F. and about 95° F., about 60° F. and about 70° F., about 63° F. and about 67° F., and preferably about 65° F. In some embodiments, the temperature of the water can be measured before entering the mix and the temperature of the mix can be monitored during the mixing process. The temperature of the water can then be adjusted accordingly to ensure that the mix maintains a satisfactory temperature. The water temperature can affect the curing process, so a tightly controlled process can be used. The temperature of the mix can ensure that the face mix does not set up too quickly, which can happen if the water is too hot. Additionally, if the water is too cold it can affect the ability to reach a final cure point. A controlled water temperature, such as those described above, can improve the properties of the face mix.

After the face mix is completely mixed 108, the face mix can be applied to the mold 110. In some embodiments a concrete release agent can be applied to the mold before the face mix is applied to the mold. In some embodiments, the face mix is sprayed onto the mold. In some embodiments, another method is used to apply the face mix to the mold, and the application method is not limiting. In some embodiments, the face mix can be applied at least about 0.05, about 0.075, about 0.1, or preferably at least about 0.125 inches thick. In some embodiments, the face mix can be applied less than about 0.5, about 0.25, or about 0.125 inches thick. In some embodiments, the face mix can be applied to a thickness of about 0.05 to about 0.5 inches, about 0.075 to about 0.25 inches, or preferably about 0.125 inches thick. The face mix can then be allowed to rest on the mold 112. In some embodiments, the face mix stiffens, or sets, for greater than about 1 minute, greater than about 2 minutes, or greater than about 3 minutes. In some embodiments the face mix stiffens for less than about 6 minutes, less than about 5 minutes, or less than about 4 minutes. In other embodiments, the face mix is allowed to stiffen on the mold for about 0 to about 10 minutes, about 1 minute to about 6 minutes, about 2 to about 5 minutes, or preferably about 3 minutes. In some embodiments, the face mix can be sufficiently stiff to allow for bonding with the back mix without fully curing, which will cause two distinct layers to form.

In some embodiments, after the face mix has sufficiently stiffened on the mold, the insert 208 may be installed 114. The insert 208 can be used to create space within the work piece 206, for example, the hollow portion of a pot or vase. In some embodiments, the insert 208 can also be sprayed with face mix. After the insert 208 is installed, the entire process tool 200 (which includes the carrier 202, sprayed mold 204 and insert 208) can be flipped upside down. This can allow the mold to be filled with the back mix. In some embodiments, the insert 208 can be inserted into the mold 204, to press the excess material throughout the mold, and therefore it may not be needed to be flipped upside down. In other embodiments, an insert may not be used, such as for a flat slab or an open mold.

The back mix is the mixture that can be used to fill the mold. These components may be filtered, inspected, and stored 180 before pre-weighing the components. These components may be pre-weighed before mixing 116. In some embodiments, the back mix can comprise cement, sand, polymer, alkali-resistant glass fibers (AR fibers), and water. The AR fibers can be, for example, roving, chopped strang, scrim, or a mix. In some embodiments, the back mix further comprises recycled glass beads, such as poraver beads. Glass beads, or other filler, can reduce the overall weight of the GFRC, while maintaining strength. In other embodiments, the back mix comprises gray fast cement, sand, an acrylic modified polymer, and water. In some embodiments, the cement is present in the back mixture at about 15% to about 75% by weight, about 40% to about 50% by weight, about 43% to about 48% by weight, or about 45% by weight. In some embodiments, the sand is present in the back mix at about 5% to about 55% by weight, about 23% to about 33% by weight, about 26% to about 30% by weight, or about 28% by weight. In some embodiments the polymer is present in the mix at about 0.05% to about 30% by weight, about 1% to about 7% by weight, about 2% to about 6%, or about 4% by weight. In some embodiments, the water is present in the back mix at about 1% to about 40% by weight, about 7% to about 17% by weight, about 10% to about 15% by weight, or about 13% by weight. In some embodiments, the poraver beads are present in the back mix at about 0% to about 45% by weight, about 1% to about 10% by weight, about 4% to about 8% by weight, or about 6% by weight. In some embodiments, the AR fibers are present in the back mix at about 0% to 15% by weight, about 0.5% to about 3% by weight, about 1% to about 2.5% by weight, or about 1.8% by weight. Other components can be added to change specific properties, such as strength or durability, in the back mix.

In some embodiments, the temperature of the water can be precisely controlled during the mixing of the back mix. In some embodiments, the temperature of the water is greater than about 40° F., greater than about 50° F., or greater than about 60° F. In some embodiments, the temperature of the water is less than about 100° F., less than about 90° F., less than about 80° F. or less than about 70° F. In other embodiments, the temperature of the water is controlled to between about 35° F. and about 95° F., about 60° F. and about 70° F., about 63° F. and about 67° F., and preferably about 65° F. In some embodiments, the temperature of the water is measured before entering the mix and the temperature of the mix is monitored during the mixing process. The temperature of the water can then be adjusted accordingly to ensure that the mix maintains a satisfactory temperature. The water temperature can affect the curing process, so a tightly controlled process can be used, as discussed above regarding the face mix.

Once the back mix is properly mixed 118, it can be applied to the mold 124. In some embodiments the back mix can be applied 120 in greater than about 1 minute, greater than about 2 minutes, greater than about 3 minutes, greater than about 4 minutes or greater than about 5 minutes. In other embodiments, the back mix can be applied in less than about 10 minutes, less than about 9 minutes, less than about 8 minutes, less than about 7 minutes, less than about 6 minutes, less than about 5 minutes or less than about 4 minutes. In some embodiments, this can be done within about 30 seconds to about 10 minutes, about 1 to about 6 minutes, or preferably about 3 to about 5 minutes. If the back mix is applied too quickly, then the face mix could be damaged. If the back mix is applied too slowly, then the face mix and back mix may not bond properly. In some embodiments, the back mix can be poured into the mold. In some embodiments, the back mix can be sprayed onto the face mix. In other embodiments, the back mix can be cast onto the face mix. The application of the back mix is not limiting.

In some embodiments, the back mix can be applied at least about 0.125, about 0.25, about 0.5, or preferably at least about 0.75 inches thick. In some embodiments, the back mix can be applied at less than about 2, about 1.5, about 1.0 or about 0.75 inches thick. In some embodiments, the back mix can be applied to a thickness of about 0.125 to about 2 inches, about 0.25 to about 1 inch, or preferably about 0.75 inches thick.

In some embodiments, a single mix process can be used, where only the face mix or only the back mix can be applied to form the work piece 206. In some embodiments, the single mix can be applied as described above with respect to the face mix or the back mix.

In some embodiments, the process tool can be vibrated 122 while applying the back mix, and sometimes the vibration continues after the back mix is fully applied. In some embodiments, the vibration can begin before the back mix is applied. In some embodiments, the process tool can be placed on a vibrating conveyor belt. For example, this could be a 1 horsepower vibrator attached to a standard conveyor belt which causes vibration at high amplitude for approximately 20 feet on the conveyor belt. In other embodiments, no vibration is used.

Once the mold has been filled with the back mix, the work piece 206 may be trowel finished 126 to create a smooth outer layer. The entire process tool 200, including the carrier 202, insert 208, and mold 204 filled with face mix and back mix, can then be placed in an oven 128 for pre-cure. In some embodiments, the temperature of the oven can be greater than about 80° F., greater than about 90° F. or preferably greater than about 100° F. The temperature of the oven may be less than about 150° F., less than about 140° F., less than about 130° F., or preferably less than about 120° F. In other embodiments, the oven temperature can be between about 60° F. to about 140° F., between about 90° F. and 110° F., or preferably between about 95° F. and 105° F. However, if the temperature is raised too high, this can cause changes in the color of the work piece 206. For example, oven temperatures greater than 200° F. can result in color changes in the work piece 206. However, in some embodiments, high temperature can be used to enact a color change.

In some embodiments, the process tool 200 can be in the oven for a pre-determined amount of time 130. In some embodiments the process tool 200 can be in the oven 132 for less than about 3 hours, less than about 2 hours, less than about 1.5 hours, or preferably about 1 hour. In some embodiments, the process tool 200 can be in the oven for greater than about 15 minutes, greater than about 30 minutes, greater than about 45 minutes, or greater than about 55 minutes. The process tool 206 can be removed from the oven 134 when the work piece 206 has sufficiently stiffened to remove the work piece 206 from the mold 204.

FIG. 1B shows an embodiment of a final cure process. This process may be completed immediately after the method of FIG. 1A, or after another method of pre-cure has been used. Once the work piece 206 has sufficiently pre-cured, the insert 208 can be removed 136 from the carrier 202. Then the mold 204 can be removed 138 from the carrier 202. Then the work piece 206 can be removed 140 from the mold 204.

In some embodiments, the work piece 206 can then be placed into the oven 142 for curing. This could either be in a different oven or the same oven as may have been used for a pre-cure. In some embodiments, the temperature of the oven can be greater than about 80° F., greater than about 90° F. or preferably greater than about 100° F. The temperature of the oven may be less than about 150° F., less than about 140° F., less than about 130° F., or preferably less than about 120° F. In other embodiments, the oven temperature can be between about 60° F. to about 140° F., between about 90° F. and 110° F., between about 95° F. and 105° F., or preferably about 100° F. However, if the temperature is raised too high, this can cause changes in the color of the work piece 206. However, in some embodiments, high temperatures can be used to enact color changes. The work piece 206 can be placed in the oven for a pre-determined amount of time 144.

In some embodiments, the work piece 206 can be in the oven 146 for less than about 3 hours, less than about 2 hours, less than about 1.5 hours, or preferably about 1 hour. In some embodiments, the work piece 206 can be in the oven for greater than about 15 minutes, greater than about 30 minutes, greater than about 45 minutes, or greater than about 55 minutes. The work piece 206 can be removed 148 once it has achieved the target cure. For example, one way to determine whether the work piece 206 has achieved the target cure is to press a finger against the work piece to determine if there is any moisture left in the work piece 206. If the work piece 206 is moist to the touch, then the work piece 206 is not sufficiently cured. A moisture gauge may also be used to test the moisture content of the work piece. The specific process for testing the sufficiency of curing is not limiting. In some embodiments, the temperatures and compositions described above can produce a work fully cured work piece with sufficient properties to use within a minimal time.

FIG. 1C shows an embodiment of a method for sealing and staining a cured work piece 206. The stain and sealer can be inspected, received, and stored 182/184, along with any packaging 186. Once the work piece 206 has cured, the work piece 206 may be cleaned 150, and then the work piece 206 may enter into various finishing steps, such as cleaning, staining, and sealing. In some embodiments, a stain and seal batch record can be selected 152. The stain can be then applied 154 to the work piece 206. The stain can be applied only to the top 4 inches of the inside of the work piece, and can be applied all over the outside of the work piece. The stain can be flashed 156 and then wiped 158. The stained work piece can then be cured 160 at an elevated temperature. The work piece 206 can then be allowed to cool 162. The seal can then be applied 164 on top of the stain and the seal can be applied to both the outside and the inside of the work piece 206, and the sealed work piece 206 can be cured 166 at an elevated temperature. Once the work piece 206 cools off 168, the work piece 206 can be inspected 170 and is ready for packaging 172, such as wrapping 174, or use. The work piece 206 can undergo one final inspection 176 after packaging 172.

Embodiments of GFRC described above can be manufactured to create architectural accents, decorative panels, countertops, or faux rocks that are of significantly reduced weight compared to standard Portland Cement. Additionally, embodiments of GFRC described above can also be manufactured into outdoor furniture, fire places, fountains and many other applications that traditional Portland cement is used for. It is possible to include additives, such as aggregates of granite, quartz or limestone, to the GFRC mix described above to create the appearance of natural stone. GFRC can be cast into ornate shapes with a high degree of detail and can mimic the look of many materials.

Although the foregoing description has shown, described, and pointed out the fundamental novel features of the present teachings, it will be understood that various omissions, substitutions, and changes in the form of the detail of the apparatus as illustrated, as well as the uses thereof, may be made by those skilled in the art, without departing from the scope of the present teachings. Consequently, the scope of the present teachings should not be limited to the foregoing discussion, but should be defined by the appended claims.

What is claimed is:

1. A method for manufacturing a glass fiber reinforced concrete comprising:
mixing a face mix comprising fast cement, sand, a polymer, and water, where the water is maintained within a temperature range of about 40° and about 100°;
applying the face mix to a mold and stiffening the face mix for about 0 to about 10 minutes;
mixing a back mix comprising fast cement, sand, a polymer, water, and glass fibers, where the water is maintained within a temperature range of about 40° to about 100°;
applying the back mix to the mold to form a work piece; and
curing the work piece at a temperature of about 80° to 150° for less than about 3 hours to form a cured work piece.

2. The method of claim 1, further comprising pre-curing the mold at a temperature of about 80° to about 150° for less than about 3 hours.

3. The method of claim 2, wherein the pre-curing the mold is at about 100° for about 55 minutes.

4. The method of claim 1, wherein the water is maintained within a temperature range of about 63° to about 67°.

5. The method of claim 1, wherein the face mix is applied to the mold through spraying or vibration premixing.

6. The method of claim 1, further comprising applying a concrete release agent to the mold before applying the face mix.

7. The method of claim 1, wherein the face mix is stiffened for about 3 to 5 minutes.

8. The method of claim 1, wherein the face mix comprises, in weight %:
about 35% to about 43% cement;
about 35% to about 45% sand;
about 1% to about 7% polymer; and
about 7% to about 17% water.

9. The method of claim 1, wherein the back mix comprises, in weight %:
about 40% to about 50% cement;
about 23% to about 33% sand;
about 1% to about 7% polymer;
about 7% to about 17% water;
about 1% to about 10% glass beads; and
about 0.5% to about 3% fibers.

10. The method of claim 1, wherein the face mix is applied to the mold at a thickness of about 0.05 to about 0.5 inches.

11. The method of claim 1, wherein the back mix is applied to the mold at a thickness of about 0.25 to about 2.0 inches.

12. A work piece manufactured from the method described in claim 1.

13. A method for manufacturing a glass fiber reinforced concrete comprising:
applying at least one layer of a face mix and a back mix to a mold, wherein the face mix and the back mix comprise a combination of cement, sand, polymer, fibers, and water;
performing a first heat treatment on the mold containing the face mix and the back mix at a temperature of about 80° to about 150° for less than about 3 hours to form a work piece; and
performing a second heat treatment on the work piece at a temperature of about 80° to 150° for less than about 3 hours.

14. The method of claim 13, wherein the first and second heat treatment are performed for about 55 minutes or less.

15. The method of claim 13, wherein the face mix is allowed to stiffen before applying the back mix.

16. A work piece manufactured from the method described in claim 13.

17. A method for manufacturing a glass fiber reinforced concrete comprising:
applying a face mix comprising fast cement, sand, a polymer, and water, where the water is maintained within a first water temperature range, to a mold and stiffening the face mix for a stiffening time;
applying a back mix comprising fast cement, sand, a polymer, water, and glass fibers, where the water is maintained within a second water temperature range, to the mold;
pre-curing the mold at a pre-cure temperature for a pre-cure time to form a work piece; and
curing the work piece at a cure temperature and a cure time to form a cured work piece;
wherein the total pre-cure and cure time is less than about 110 minutes.
